(19) United States
(12) Patent Application Publication
(10) Pub. No.: US 2011/0076395 A1
(43) Pub. Date: Mar. 31, 2011

(54) METHOD FOR IMPARTING TOPICAL HOLOGRAPHIC EFFECT TO A POLYMERIC FILM SUBSTRATE

(76) Inventors: Haiyan Sun, Beijing (CN); Jing Zhang, Beijing (CN)

(21) Appl. No.: 12/889,568

(22) Filed: Sep. 24, 2010

Related U.S. Application Data
(60) Provisional application No. 61/246,179, filed on Sep. 28, 2009.

(51) Int. Cl. B05D 5/06

(52) U.S. Cl. 427/164; 427/162

(57) ABSTRACT

A method for imparting topical holographic effect to a polymeric film substrate comprising a first surface and a second surface. The method comprises the steps of embossing the first surface of the polymeric film substrate to impart a holographic effect to the polymeric film substrate; and printing the embossed first surface of the polymeric film substrate with ink and/or varnish on selected area which is intended not to have holographic effect and leaving the unprinted embossed area to provide a holographic effect.

### CROSS REFERENCE TO RELATED APPLICATIONS

This application claims the benefit of U.S. Provisional Application No. 61/246,179 filed on Sep. 28, 2009.

### FIELD OF THE INVENTION

The present invention relates to a method for treating a polymeric film substrate. Specifically, the present invention relates to a method for imparting topical holographic effect to a polymeric film substrate. The treated polymeric film substrate can be used as a packaging material for variety kinds of commodities.

### BACKGROUND OF THE INVENTION

Commodities are commonly packaged in packaging material for sale. To improve the attractiveness of the packaged commodities on the shelf and also to provide information about the packaged commodities, colors, graphics, words, etc. are printed on the packaging material. Nowadays, since consumers usually have too many choices for each type of commodities at the store, various efforts have been made to improve the attractiveness and eye-catching effect of packaging material so that the packaged commodity could be easily found by the shopper.

For example, a packaging material of paper substrate which is treated to provide shiny and/or hologram-like effect is available in the market. Commercially, there are two methods to make this hologram-like effect on paper substrate. One method is to laminate a metalized holographic plastic film on a paper substrate. The other method is to coat a paper substrate with a thin layer of varnish and then emboss the varnish layer. The embossed varnish layer provides desirable holographic effect. For plastic film material, it is known that by directly embossing the polymeric film substrate, the embossed polymeric film substrate can provide a holographic effect due to the mechanical deformation of the film surface.

When an embossed polymeric film substrate which provides a hologram-like effect is used as a packaging material, it is desirable to have topical holographic effect as the comparison between the holographic area and non-holographic area emphasizes and boosts the holographic effect. In addition, for a polymeric film substrate having topical holographic effect, it is desirable to concisely control the location where holographic effect is provided so as to coordinate the holographic effect with other design elements. For example, it is desirable to provide topical holographic effect on the first surface of a polymeric film substrate at specified location so that the holographic effect coincides with the printing of a product logo on the second surface of the polymeric film substrate. By doing this, the attractiveness and eye-catching effects of the product logo can be greatly improved.

In theory, topical holographic effect can be delivered to a polymeric film substrate by topically embossing the polymeric film substrate, for example, by only embossing an area on the first surface of a polymeric film substrate where a product logo is printed on the same area of the second surface of the polymeric film substrate. However, it is challenging to provide concise registration between embossing area on the first surface and printing element on the second surface in separated embossing and printing process. In addition, a polymeric film substrate tends to be stretched or otherwise distorted when subjected to an embossing treatment. Therefore, it is technically challenging to concisely control the embossing area on the first surface of a polymeric film substrate so as to ensure the embossing area to coincide with the area on the second surface of the polymeric film substrate where a product logo is printed. In addition, under the above described theoretical method, when the design of an artwork printed on the second surface of the film substrate is changed, the heated engraved embossing roll has to be changed accordingly to register the topically embossed area on the first surface with a printed product logo on the second surface. Thus, the manufacturing cost and production complexity is increased.

Therefore, a need exists for a method for imparting topical holographic effect to a polymeric film substrate. Such method should be simple and convenient to execute at an industrial scale and should be able to provide concise control on the location where the holographic effect is provided.

### SUMMARY OF THE INVENTION

The present invention addresses the aforementioned need by providing a method for imparting topical holographic effect to a polymeric film substrate, said polymeric film substrate comprising a first surface and a second surface. The method of the present invention comprises the steps of:

(a) embossing the first surface of said polymeric film substrate to impart a holographic effect to the embossed area on the polymeric film substrate; and

(b) printing said embossed first surface of said polymeric film substrate with ink and/or varnish on selected area which is not intended to provide holographic effect and leaving the unprinted embossed area to provide said holographic effect.

In a preferred embodiment, the polymeric film is a transparent film, and the method of the present invention further comprises a step of printing the second surface of the polymeric film substrate with ink.

The method of the present invention can provide concise control on the location where holographic effect is provided on a polymeric film substrate and can be conveniently applied at an industrial level. The embossing step firstly imparts holographic effect to the first surface of a polymeric film substrate at the embossed area. By secondly printing on the embossed surface of the polymeric film substrate with ink and/or varnish at selected area, the holographic effect on the selectively printed area is removed. Thus, the unprinted embossed area provides the desired topical holographic effect.

By taking the embossing step first, followed by the printing step, the location providing holographic effect can be concisely controlled by the control of printing area, rather than trying to control the embossing area. Since an embossing step usually involves the application of heat and/or high pressure, the embossing treatment of a polymeric film substrate tends to cause the polymeric film substrate stretched, and thus creates additional difficulties in concisely control the location which is intended to provide holographic effect. According to the method of the present invention, the location where holographic effect is provided on a polymeric film substrate can be concisely controlled by printing ink and/or varnish on selected area of the embossed surface which is intended not to provide holographic effect, and leaving the unprinted embossed area to provide the desirable holographic effect. In other words, the location providing holographic effect is controlled by the printing step, rather than the embossing step according to the method of the present invention. Therefore, the difficulty of concisely control the location providing holographic effect in a embossing treatment is solved without the need for additional investment on the current equipments and facilities. In a preferred embodiment of the present invention, the polymeric film is a transparent or translucent polymeric film, and the method of the present invention includes the step of printing the second surface of the transparent polymeric film with ink. Characters and/or graphics which are intended to be seen through the location providing holographic effect are printed on the second surface of the polymeric film substrate to coincide with the unprinted embossing area on the first surface of the polymeric film substrate.

### BRIEF DESCRIPTION OF THE DRAWINGS

FIG. 1 is a schematic view of an embossing step useful in the present invention for embossing a polymeric film substrate to create a pattern of fine grooves.

FIG. 2.1 is a schematic cross-sectional view of a polymeric film substrate before embossing treatment.

FIG. 2.2 is a schematic cross-sectional view of a polymeric film substrate after embossing treatment.

FIG. 3 is a schematic cross-sectional view of a polymeric film substrate having printed ink or varnish on the selected embossed area.

FIG. 4 is a schematic cross-sectional view a laminated polymeric film substrate comprising a film layer being treated according to the method of the present invention.

### DETAILED DESCRIPTION OF THE INVENTION

Embossing oremboss as used herein refers to a process of creating a three-dimensional image or pattern on a substrate, such as paper, a polymeric film or other ductile materials. The embossing process imparts unevenness imperceptible to unaided human eyes on the treated surface of a substrate. Such imperceptible unevenness provides a hologram-like effect to unaided human eyes under light. In a preferred embodiment, the embossed imperceptible pattern is paralleled and equally spaced fine grooves. Embossing treatment of a polymeric film substrate is well known in the art and is typically accomplished with a combination of heat and pressure on the polymeric film substrate. The embossing step of the present invention can be conveniently conducted by any known method in the art.

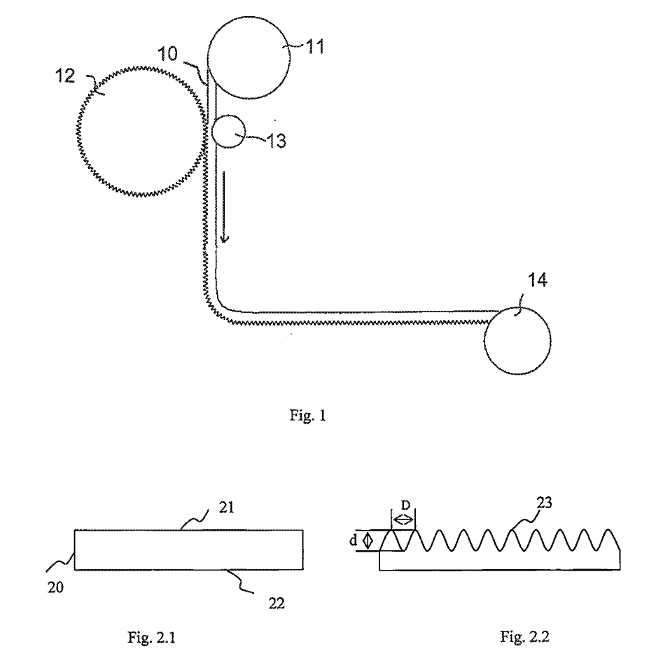

Referring to the figures, FIG. 1 is a schematic view of an embossing step useful in the present invention for embossing a polymeric film substrate. A preferred embossing method for use in the present invention is known as “soft embossing”. “Soft embossing” is a process by which the film may be embossed at a pressure of about 200 psi so as to emboss only one side of the film and leave the opposite side of the film essentially untouched. Referring to FIG. 1, a preformed, flat, longitudinally extending, endless web of a polymeric film substrate, 10 is supplied by an unwinding film roll, 11. The polymeric film substrate, 10 is unwound from the unwinding film roll, 11 and is fed through the nip between a counter-rotating embossing roll, 12 and a backup roll, 13. The embossing roll, 12 has the desired embossing pattern on its outer cylindrical surface. The pattern may be any pattern desired, i.e., it may be a male pattern wherein the surface of the embossing roll, 12 has uniform protuberances imperceptible to unaided human eyes extending outwardly from its surface. In a preferred embodiment, the embossing roll, 12 has repeated pattern on the entire outer surface of the roll. To obtain a permanent embossed pattern, polymeric film is preferably heated to a temperature between the glass transition temperature and crystalline melting temperature of the polymer material, more preferably to a temperature of 20° C. lower than the crystalline melting temperature of the polymer material by the heated embossing roll. Backup roll, 13 is preferably a cylindrical metal roll having a resilient covering over its outer cylindrical surface and is pressed into contact with the embossing roll with sufficient pressure to press the polymeric film substrate, 10 into the embossing pattern on the embossing roll, 12 in order to create an embossed first surface of the polymeric film substrate. Pressure applied to the embossing roll and the backup roll can be conveniently selected according to the particular type of polymer material being processed. Generally, pressure in the range of 50 to 500 psi is found satisfactory in the present invention. After the embossing treatment, the treated polymeric film substrate, 10 is then moved to a second film roll, 14 to be wound up and is ready for printing.

Alternatively, the polymeric film substrate, 10 can be heated by a heating equipment to its softening points before being passed through the nip between the embossing roll and backup roll. Such embossing method is well known in the art and described, for example in U.S. Pat. No. 3,950,480.

FIG. 2.1 and FIG. 2.2 are schematic cross-sectional views of a polymeric film substrate, 20 before and after the embossing treatment. As shown in FIG. 2.1, the polymeric film substrate, 20 has a first surface, 21 and a second surface, 22. Before embossing treatment, the first surface, 21 and the second surface, 22 are substantially flat. As shown in FIG. 2.2, after the embossing treatment as described above, the first surface, 21 of the polymeric film substrate is imparted with the pattern 23 which is parallel and equally spaced fine grooves. Preferably, the fine grooves being spaced apart from each other uniformly, i.e. the distance between two adjacent grooves, D as shown in FIG. 2.2 is about 0.1-10 microns, preferably 0.8-1.4 microns and the depth of the fine grooves, d as shown in FIG. 2.2 is at least 0.01 microns and up to 8 microns, preferably from about 0.2 to about 0.6 microns. The pattern, 23 provides a hologram-like effect to unaided human eyes under light because the fine grooves on the first surface of the film substrate perform as diffraction gratings. Diffractive and interference effects occur when light is incident on the fine grooves, and thus, light is reflected in discrete directions with iridescent colors and dynamic holographic optical effects produced.

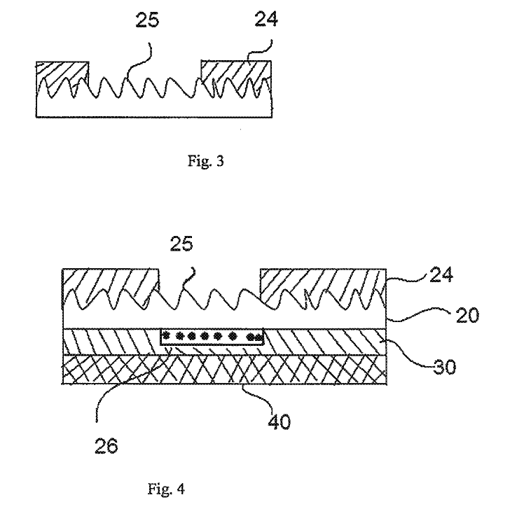

FIG. 3 is a schematic cross-sectional view of a polymeric film substrate with selected area being printed with ink or varnish. As shown in FIG. 3, the first surface of the polymeric film substrate which is embossed through an embossing process is printed with ink or varnish at printing area, 24, the unprinted embossed area, 25 provides the desirable topical holographic effect. In a preferred embodiment, the polymeric film is a transparent or translucent and the printing area, 24 is printed with varnish. The varnish-printed area is transparent and allows the color, character, graphics, etc. printed on the second surface of the transparent polymeric film substrate viewable through the polymeric film substrate. Varnish well known in the art can be used in the present invention. Non-limiting illustrated varnish useful in the present invention can be matt varnish or gloss varnish. Preferably, the refractive indexes in the embossed area and the varnish-printed area on the first surface are substantially same so the incident light passes straight through. Preferably the varnish is a matt varnish as the matt varnish with non-highly reflective and porous powders has a rough surface and can diffuse the light to provide the desirable sharp contrast between the printed area, 24 and hologram-like area 25. Preferred matt varnish useful in the present invention includes are commercially available, for example from DIC, Seigwerk and Yangzijing from YIP's Chemical.

FIG. 4 is a schematic cross-sectional view of a transparent or translucent polymeric film substrate having topical hologram-like area of a first surface of the polymeric film substrate and a printing element, 26 on the second surface of the polymeric film substrate. The entire second surface of the polymeric film substrate can be printed with ink to provide a background color or graphics. In a preferred embodiment, the printing element, 26 is printed on the second surface of the transparent or translucent polymeric film substrate at selected location which coincides with the unprinted embossed area, 25 of the first surface of the polymeric film substrate. Preferably, the second surface is printed with an ink containing particles to create highly reflective printing surface. Preferably, the particles are selected from the group consisting of aluminum particles, silver particles, gold particles, cobalt particles, chromium particles, platinum particles, palladium particles, nickel particles, carbon particles, aluminum oxides, titanium dioxide, iron oxides, zirconium oxide, zinc oxide, zinc sulfide, bismuth oxychloride, indium oxide, indium-tin-oxide, tantalum pentoxide, ceric oxide, yttrium oxide, europium oxide, hafnium nitride, hafnium carbide, hafnium oxide, lanthanum oxide, magnesium oxide, neodymium oxide, praseodymium oxide, samarium oxide, antimony trioxide, silicon carbide, silicon monoxide, selenium trioxide, tin oxide, tungsten trioxide, and a mixture thereof.

Illustrative printing element, 26 can be a product brand name, a product logo as well as any other element the attractiveness of which is intended to be boosted by the topical hologram-like effect through the unprinted embossed area, 25. In a preferred embodiment, the printing element, 26 is a product logo printed on the second surface of the transparent or translucent polymeric film substrate at a location which coincides with the imprinted embossed area, 25 on the first surface of the polymeric film substrate, 20. The registration between locations for printing element, 26 on second surface and unprinted embossed area, 25 on first surface can be achieved by printing plate fabrication and on-line printing process control.

In a preferred embodiment, the polymeric film substrate, 20 is laminated to a second substrate, 40 by a glue layer, 30, as shown in FIG. 4. The second substrate, 40 can provide the function of supporting the polymeric film substrate, protecting the color-print on the second surface of the polymeric film substrate and/or being a sealable layer. The second substrate, 40 can be a paper substrate, a second polymeric film substrate. In a preferred embodiment, the second substrate, 40 is a polyolefin film, such as polyethylene film, heat sealable polypropylene film, preferably, the second substrate, 40 is a low density polyethylene film.

There's no specific limitation on whether the embossed first surface, 21 is printed first, followed by the printing on the second surface, 22 or the second surface, 22 is printed first, followed by the printing on the first surface, 21. There's no specific limitation on whether both surfaces are printed on-line or off-line. Preferably, both surfaces are printed on line using a printing equipment which can print, one surface first and then automatically turn the film for printing on the other surface. Varnish and/or ink may be printed on a film surface by printing techniques including, but not limited to letterpress, flexography, gravure, offset lithography, screen. All methods are well known in the art.

Letterpress, the oldest method of printing, involves ink or other equivalent material being applied to the top of a raised surface. This surface is pressed against a substrate, thus transferring the ink to the substrate. Flexographic printing uses a printing plate, often cylindrical, made of rubber, plastic, or other flexible material. Ink is applied to a raised image on the plate. The plate is then placed in contact with a substrate, and ink is transferred to the substrate. Water-based and solvent-based inks are used in flexography. Most inks used are fast drying which makes flexography particularly well-suited for printing on plastics, foils, compressible surfaces, and other nonabsorbent substrate. Gravure printing uses a print cylinder having depressions of varying depths that are etched into the cylinder. This method of printing is performed by partially immersing the etched cylinder (generally about a fourth of the cylinder diameter) into an enclosed fountain or trough of ink. The etched cells, which produce the image, are filled with ink, and the surface the cylinder also becomes coated with ink. Since the surface of the cylinder is non-image producing, ink is not desirable on the cylinder surface. This undesired ink is removed by a doctor blade or knife which wipes all of the surface ink from the cylinder. As the printing cylinder comes in contact with the substrate, the ink contained within the cells is transferred to the substrate. Gravure is ideal for continuous printing operations and the printing of very long runs. Generally, solvent-based inks are used in gravure printing. Lithographic printing, or offset lithography, is a printing method that utilizes surface characteristics on an image carrying offset plate. Offset plates are typically made from a thin paper, plastic, or a metal sheet which once exposed and processed can be wrapped around a cylinder of a press for printing. The offset plate contains two areas: an image area that is hydrophobic and a non-image area that is hydrophilic. While the basic principle is common, there are many differences between offset plates and the method they use to separate the image from the non-image areas. Generally, ink adheres to the hydrophobic image area while being repelled from the hydrophilic image area. The ink and watered offset plate may be printed on a second cylinder usually coated in rubber. The second cylinder then off-sets this ink and water impression onto the substrate. Screen printing utilizes a porous screen made from silk or other polymeric material. The screen is attached to a frame. A stencil is produced on the screen either photo-mechanically or manually. The non-printing areas are protected by the stencil. Printing is done on the substrate under the screen by applying a viscous ink to the screen. The ink is forced through the fine openings of the screen with a rubber squeegee or roller.

The materials useful as polymeric film substrate of the present invention can be derived from thermoplastic polymers. In general, the term “thermoplastic polymer” is used herein to mean any thermoplastic polymer which can be used for the preparation of polymeric films. Examples of thermoplastic polymers useful for the present invention include, by way of illustration only, polyolefins and polyesters. Even more preferred are those polyolefins which contain only hydrogen and carbon atoms and which are prepared by the addition polymerization of one or more unsaturated, monomers. Examples of such polyolefins include, among others, polyethylene, polypropylene, poly(1-butene), poly(2-butene), poly(1-pentene), poly(2-pentene), poly(3-methyl-1-pentene), poly(4-methyl-1-pentene), 1,2-poly-1,3-butadiene, 1,4-poly-1,3-butadiene, polyisoprene, and the like. In addition, such term is meant to include blends of two or more polyolefins and random and block copolymers prepared from two or more different unsaturated monomers. Because of their commercial importance, the most preferred polyolefins are polyethylene and polypropylene. Preferred polyester is PET (polyethylene terephthalate). In a specific preferred embodiment, the polymeric film substrate useful in the present invention is biaxially oriented polypropylene (BOPP) having a thickness of 15 to 25 microns, preferably a thickness of 18 to 22 microns. BOPP material is preferred because it is a commonly commercially available material for heat embossing process and can be heat sealable on one side or both sides to provide sealing property.

In a preferred embodiment, the polymeric film substrate treated according to the present invention is laminated to a second substrate. The second surface of the polymeric film substrate can be attached to a second substrate by any known techniques in the art. The second substrate may perform one or more functions of supporting the polymeric film substrate, protecting the ink printing on the second surface of the polymeric film substrate or being a seal layer. The second substrate can be a paper, a second polymeric film substrate. Materials useful as the second polymeric film substrate can be those as described above with respect to the polymeric film substrate. In a preferred embodiment, the second substrate is a polyolefin film selected from the group consisting of a polyethylene film, polypropylene film; polyethylene film is most preferred for its good sealability.

### EXAMPLES

A commercially available transparent single layer heat sealable biaxially oriented polypropylene (BOPP) film having a thickness of 20 microns is fed into a Nantong Tianhong YM 1200A embossing machine at a speed of 60 m/min. The heat sealable surface of BOPP film is embossed via a heated engraved roll at a temperature of 140° C. and pressure of 400 psi to provide desirable parallel and equally spaced fine grooves having a distance between two adjacent grooves of about 0.8 to 1.4 microns and a depth of about 0.2 to 0.6 microns. The embossed BOPP film roll is wound up and transferred to 11-color gravure printing machine, ZhongDao GX-II-11 which has film auto-turning capability. The second surface of the embossed BOPP film is first printed with ink, and the film is automatically turned to its first surface for printing with matt varnish. The matt varnish printed area on the first surface removes holographic pattern, but the unprinted embossed area on the first surface maintain the holographic pattern. The registration of graphics on the second surface and the unprinted embossed area on the first surface is achieved by printing plate design.

The printed BOPP film roll is then transferred to a lamination machine, TaiWan Wei Li WDL-100 for being laminated with a 30 microns thickness low density polyethylene (LDPE) film by dry lamination process. Glue is applied between the second surface of the BOPP film and the LDPE film. Both films pass through a nip of two pressing rolls to form a lamination film. The laminated roll is then stored in a CTCH room for 48 hrs to cure the glue.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for imparting topical holographic effect to a polymeric film substrate, said polymeric film substrate comprising a first surface and a second surface, wherein said method comprising the steps of:
(a) embossing the first surface of said polymeric film substrate to impart a holographic effect to the embossed area on the polymeric film substrate; and
(b) printing said embossed first surface of said polymeric film substrate with ink and/or varnish on selected area which is intended not to have holographic effect and leaving the unprinted embossed area to provide a holographic effect.

2. The method of claim 1, wherein said polymeric film substrate is a transparent polymeric film substrate.

3. The method of claim 1, wherein said first surface is embossed with a pattern of parallel and equally spaced fine grooves, said fine grooves being spaced apart from each other uniformly by about 0.1-10 microns and being at least 0.01 microns deep.

4. The method of claim 2, wherein said transparent polymeric film substrate is selected from a group consisting of a polyethylene film, biaxially oriented polypropylene film and polyethylene teraphthalate film.

5. The method of claim 2, wherein said embossed first surface of the polymeric film substrate is printed with varnish and said second surface of said polymeric film substrate is printed with ink.

6. The method of claim 5, wherein the refractive indexes in the embossed area and the varnish-printed area on the first surface are substantially same.

7. The method of claim 5, wherein the ink for printing the second surface containing reflective particles selected from the group consisting of aluminum particles, silver particles, gold particles, cobalt particles, chromium particles, platinum particles, palladium particles, nickel particles, carbon particles, aluminum oxides, titanium dioxide, iron oxides, zirconium oxide, zinc oxide, zinc sulfide, bismuth oxychloride, indium oxide, indium-tin-oxide, tantalum pentoxide, ceric oxide, yttrium oxide, europium oxide, hafnium nitride, hafnium carbide, hafnium oxide, lanthanum oxide, magnesium oxide, neodymium oxide, praseodymium oxide, samarium oxide, antimony trioxide, silicon carbide, silicon monoxide, selenium trioxide, tin oxide, tungsten trioxide, and mixtures thereof.

8. The method of claim 5, wherein said unprinted embossed area on the first surface of the polymeric film substrate coincides with a printing element on the second surface of polymeric film substrate.

9. The method of claim 5, wherein said polymeric film substrate is laminated to a second substrate selected from the group consisting of paper and a second polymeric film substrate.

10. The method of claim 10, wherein said second substrate is a polyolefin film selected from the group consisting of a polyethlyene film and polypropylene film.

11. The method of claim 1, wherein said embossing step is conducted at a temperature between the glass transition temperature and crystalline melting temperature of the polymer.
